(19) United States
(12) Patent Application Publication
(10) Pub. No.: US 2002/0196552 A1
(43) Pub. Date: Dec. 26, 2002

(54) Pixelated window and lens apparatus and process

(76) Inventor: Ray M. Alden, Raleigh, NC (US)

Correspondence Address: Ray M. Alden, 808 Lake Brandon Trail, Raleigh, NC, 27610, US

(21) Appl. No.: 09/891,058

(22) Filed: Jun. 25, 2001

(51) Int. Cl. G02F 1/03; G02F 1/07; G02B 27/10; G02B 3/00; G02B 7/00; G02B 9/00; G02B 11/00; G02B 13/00; G02B 15/00; G02B 17/00; G02B 25/00

(52) U.S. Cl. 359/625; 359/620; 359/245

(57) ABSTRACT

In a preferred embodiment, this application describes a system for pixilating a window. A means is provided for separating electromagnetic energy entering a window according to its focal point. Means are provided for separating trajectories of electromagnetic radiation at a curve where its focal points form and for selecting which trajectories of electromagnetic energy will exit the window. A means if provided for selecting at what trajectory said selected electromagnetic energy will exit the window. Multiple users of the window will each see the same views from their different respective vantage points.

### BACKGROUND FIELD OF INVENTION

This invention relates to dynamic windows. More specifically, windows that are directional with regard to selecting from which direction light is accepted to pass therethrough. The window can also select which direction light will travel therefrom. The window can be caused to magnify the view provided therethrough. The window can be caused to provide a static view such that users each viewing the window from different perspectives share a common view.

### BACKGROUND-DESCRIPTION OF PRIOR INVENTION

The concept and process for creating a variable view window using variable prisms in series has been pioneered by the present inventor. One characteristic of all windows conceived heretofore is that the view provided therethrough is altered when a user changes his position relative thereto. The present invention is a variable view window which pixelates the window such that a user can vary the view provided by the window and create a view which is static as the user changes position relative thereto. Additionally the present invention is zoom able at the user's discretion. Thirdly, the present invention enables the users to select which view is provided by the window.

### SUMMARY

The invention described herein represents a significant new body of art relating to directional window technology. It enables a user to select the view provided by a window nearly instantaneously. It enables several viewers from different perspectives to simultaneously see light passing through a window from a single perspective. It enables the users to magnify the view of an object outside of a window. In a first embodiment, all of these things can be achieved with no physical motion of any window components. In a second embodiment, a small physical motion of two window components relative to one another enables the user to select alternate views, wherein a range of views are possible through the window simultaneously.

### OBJECTS AND ADVANTAGES

Accordingly, several objects and advantages of my invention are apparent. It is an object of the present invention to provide a window which is nearly instantly alterable with regard to the selection of what light trajectory angles will pass therethrough. This enables the user to select what view is provided by the window. It is an object of the present invention to provide a window which is nearly instantly alterable with regard to the selection of what light trajectory angles will pass therefrom. It is an object to provide a window which enables multiple users from different viewing perspectives to view the same scene simultaneously. It is an object to enable the user to magnify the view of an object they are viewing through the window provided. It is an advantage to provide a window which achieves these objects with no physical movement required in a first embodiment and with minimal physical motion required in a second embodiment. The apparatus described is designed to be rugged, reliable, cost effective and to minimize resource requirement while being mass produced in any size or shape. It should be noted that the technology provided herein can be applied to any field which uses windows and/or lenses such as telecommunications, entertainment, photography, optics, science, engineering, telescopy, building architecture, automobiles, and etc.

### DRAWING FIGURES

FIG. 1 illustrates a cross section view of a single pixel cell of the present variable view window.

Figure is a blown up portion of the PDLC liquid crystal layer of FIG. 1.

FIG. 3 is a blown up view of a gradient index lens replacing the fiber optics of FIG. 2.

FIG. 4 illustrates an alternate embodiment where mechanical motion enables view selection.

FIG. 5 is an exploded view of the first embodiment with a direction of light selected.

FIG. 6 illustrates the PDLC configuration that achieves the light transmittance for FIG. 5.

FIG. 7 is an exploded view of the first embodiment with a magnified view of an object.

FIG. 8 illustrates the PDLC configuration that achieves the light transmittance for FIG. 7.

### DESCRIPTION

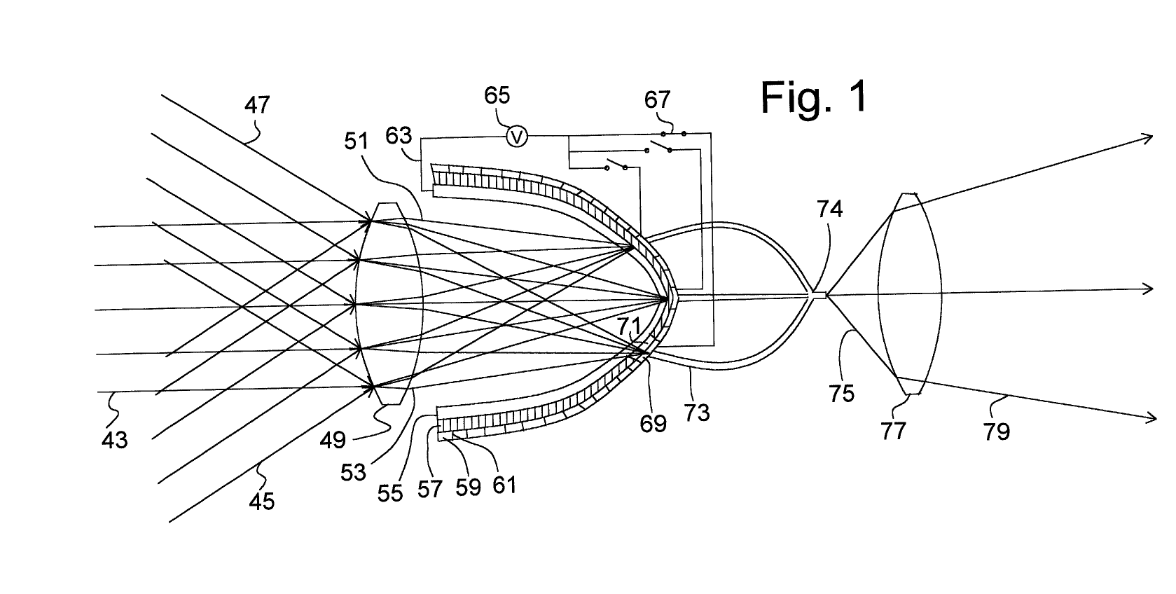

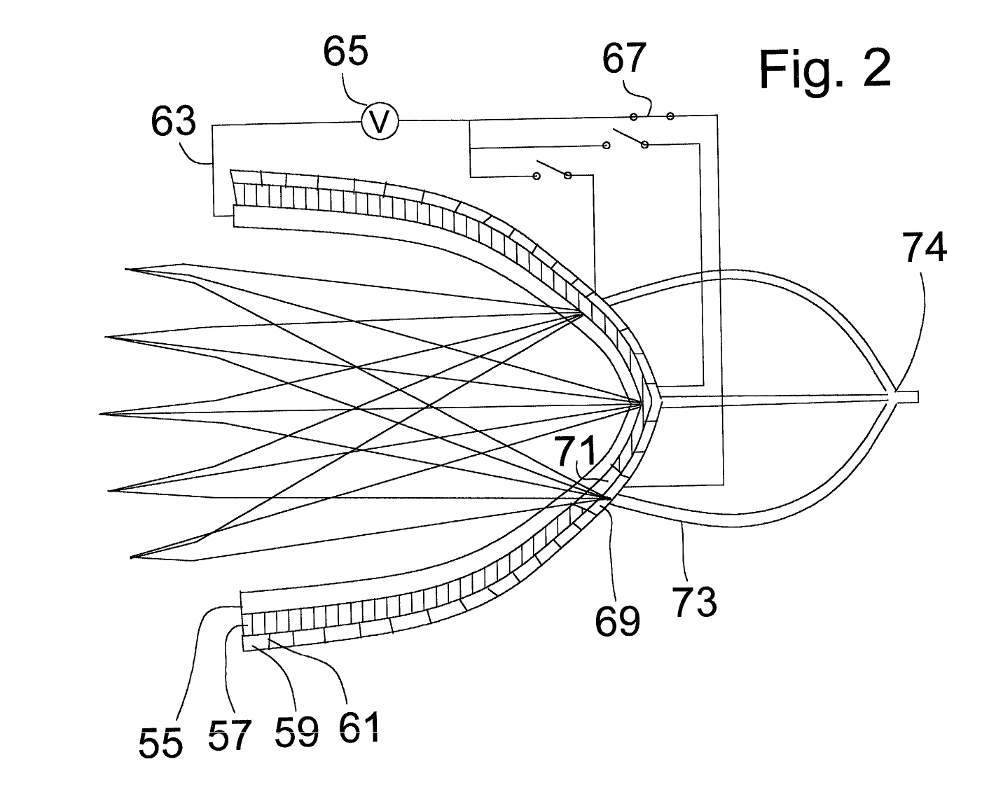

FIG. 1 illustrates a cross section view of a single pixel cell of the present variable view window. A primary optic 49 is a lens transparent to at least some frequencies of electromagnetic energy capable of producing a focal point from afocal rays, it is positioned to receive incident light. A first wall 55 is transparent to at least some frequencies of electromagnetic radiation and at least one side of it is manufactured to resemble the shape of the curve at which focal points from 49 naturally converge. 55 is also a transparent electrode. A first side of an electric circuit 63 is connected to 55. A second wall 59 is transparent to at least some frequencies of electromagnetic radiation and at least one side of it is manufactured to resemble the shape of the curve at which focal points from 49 naturally converge. It consists of an array of transparent electrodes such as an activated electrode 69. Each electrode in 59 is separated by an insulating similar to sample insulating layer 61 which enables individual electrical communication to each of the transparent electrodes. Each electrode in the 59 is in separate communication with the voltage source 65. Sandwiched between 55 and 59 is a layer of electro active material 57 which is capable from transitioning from an opaque state to a transparent state when an electric current is applied thereto or removed therefrom. 57 can be PDLC (polymer dispersed liquid crystal). Note that 57 also resides approximately along the curve of focal points produce by 49. Closed switch 67 indicates that current is applied to between 69 and 55 such at a region of 57 is transparent at a transparent region 71. A series of fiber optic cables are attached to 59 such as fiber optic 73. Note that these fiber optic also reside approximately along the focal curve created by 49. Each of the fiber optics converge and are welded together at fiber optic junction 74. Light that passes through 74 will emerge as selected light 75. 75 light then passes through a final lens 77 where it can be viewed by a user.

FIG. 2 is a blown up portion of the PDLC liquid crystal layer of FIG. 1. The PDLC 57 can be more readily seen. Note that the PDLC 57 and the fiber optics such as 73 are positioned at the focal points of the light. Note that region 71 is transparent due to the electric current applied at 69 and 55 through 63 and 67.

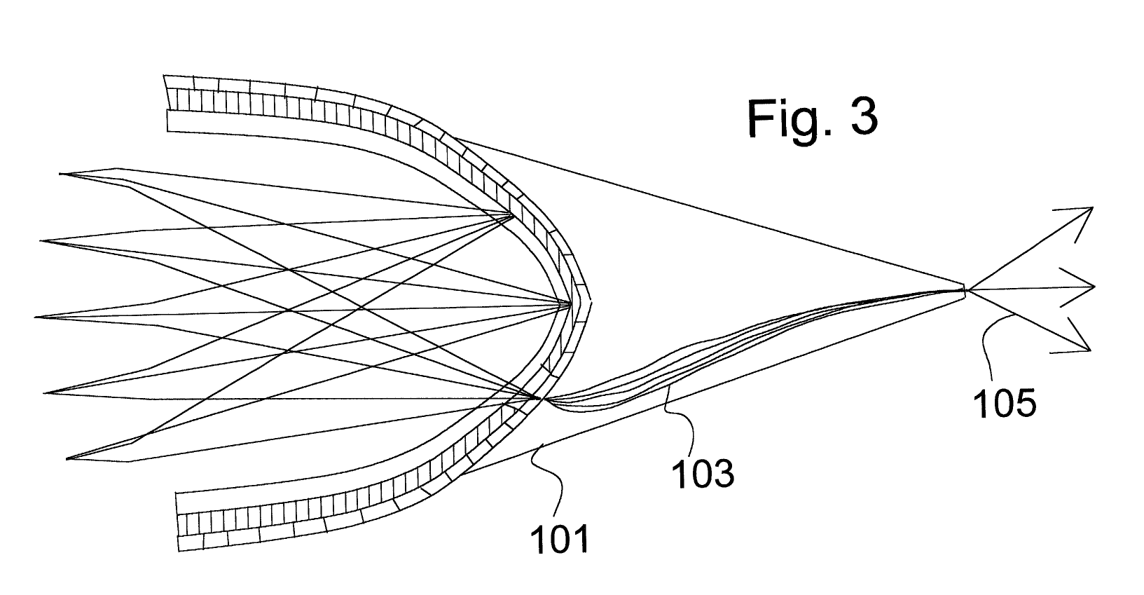

FIG. 3 is a blown up view of a gradient index lens replacing the fiber optics of FIG. 2. A gradient index lens 101 has replaced the fiber optics described in FIGS. 1 and 2. The gradient index lens is manufactured according to techniques well known.

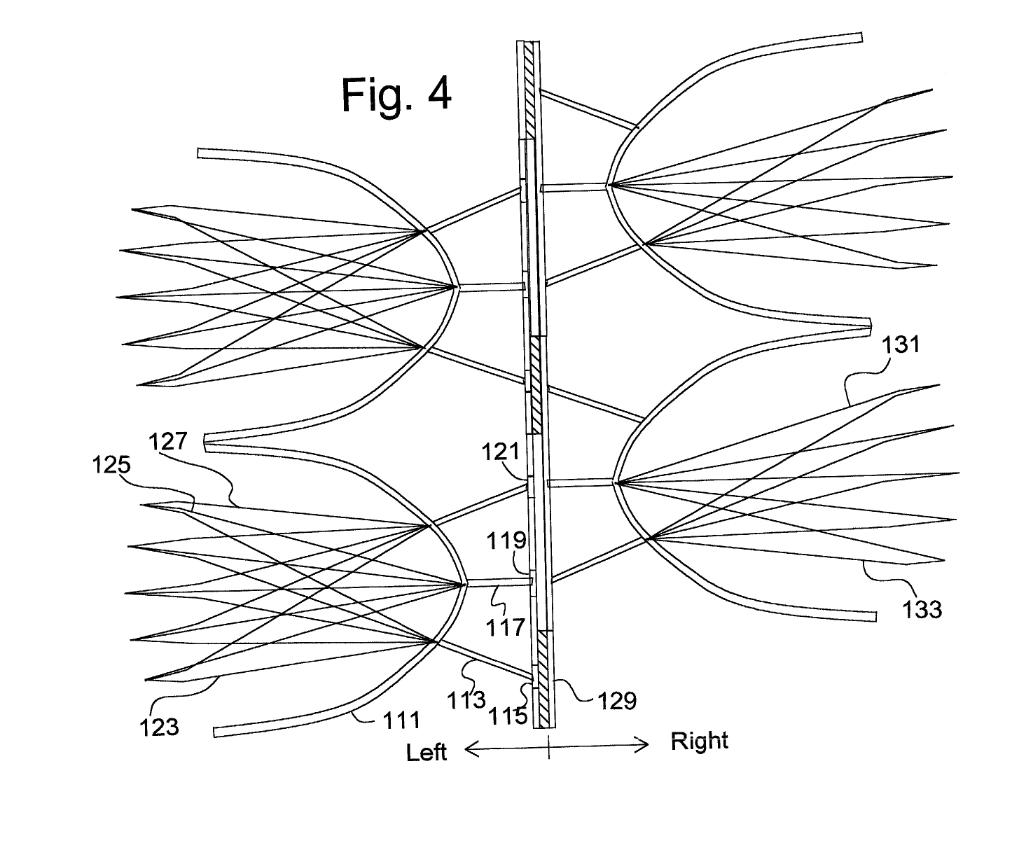

FIG. 4 illustrates an alternate embodiment where mechanical motion enables view selection. Components of the system are similar to those of FIG. 1 except that the PDLC does not reside on the curve of the focal points. The PDLC resides in a flat plane. First flat PDLC resides between a first left transparent electrode section 115 and a right transparent electrode 129. Note that the 115 is not active and the PDLC in its region is therefore opaque. A second left electrode 119 and a third left electrode 121 are activated in conjunction with 129 such that the PDLC in each of their regions is transparent. The right side of FIG. 4 is similar to the left side of FIG. 4. Note that the right side can be slid relative to the left side such that fiber optics such as a first slid fiber optic 117 on the left side can be aligned as desired with the fiber optics on the right side. This enables the user to select which light trajectories on the right will be passed through the window and what their resultant trajectories will be after emerging from the right side of the window.

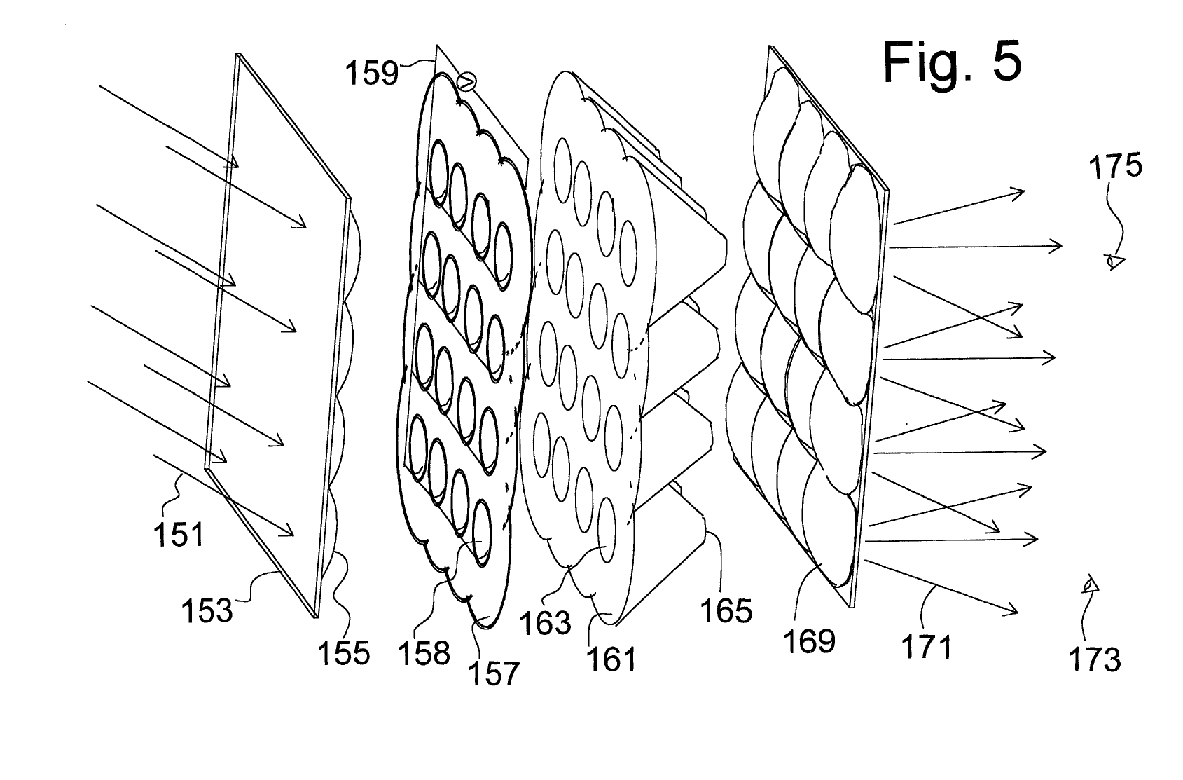

FIG. 5 is an exploded view of the first embodiment with a direction of light selected. The element of FIG. 5 are those of FIG. 3 except that are assembled in array. Ideally, the array show would be roughly 1 inch by 1 inch by 1 inch. In practice a window would be comprised of many such arrays. A first window side is a flat transparent structure 153 on one side. On the opposite side a series of lenses are incorporated such as a first lenslet 155. The 153 with 155 can be molded glass of plastic with a flat side and a side having lenses. (Alternately both sides can be flat and the lenses can be formed by refractive index gradients therein.) A second array of elements is the 157 PDLC array. It consists of electrical architecture such as electrical circuit 159. the 157 also consists of a series of recessed PDLC zones such as PDLC zone 158. Each of these zones has PDLC sandwiched between a series of transparent electrodes (as previously described) such that regions of the PDLC can be caused to transition between transparent and opaque states as desired. The PDLC recesses are designed to conform with and reside along the focal curve of the 155 as previously discussed. A gradient lens array 161 is comprised of an array of gradient lenses similar to that described in FIG. 3. Each lens has a recessed lens zone 163 such that the 157 resides therein and conforms thereto. Each of the gradient index lenses has a second end 165 which is aligned with though separated from a final lens in array 169. the final lens array is manufactured in a sheet similar to the 153 but may have other optical properties (such as different focal lengths) than 153. The 153,157, 161, and 169 are here shown in exploded view but in practice, they are assembled together within a frame structure such that they are a cohesive unit.

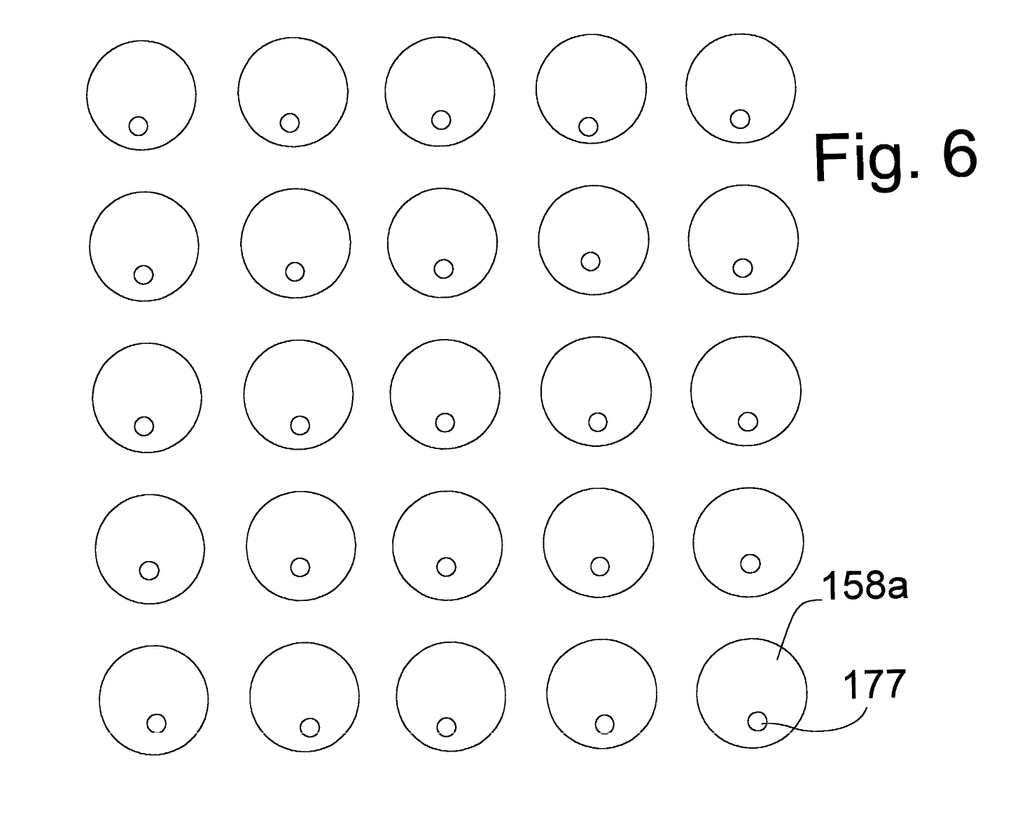

FIG. 6 illustrates the PDLC configuration that achieves the light transmittance for FIG. 5. Illustrated are the PDLC recessed regions of FIG. 5. Each PDLC recess has a small portion activated. The PDLC at 158a has an active region 177 which is transparent due to the electric current applied thereto. Since the PDLC resides along the focal curve of the lens as described in FIG. 5, a select trajectory of light passes therethrough. The PDLC array in conjunction provides a coherent view through the window with a user selected view.

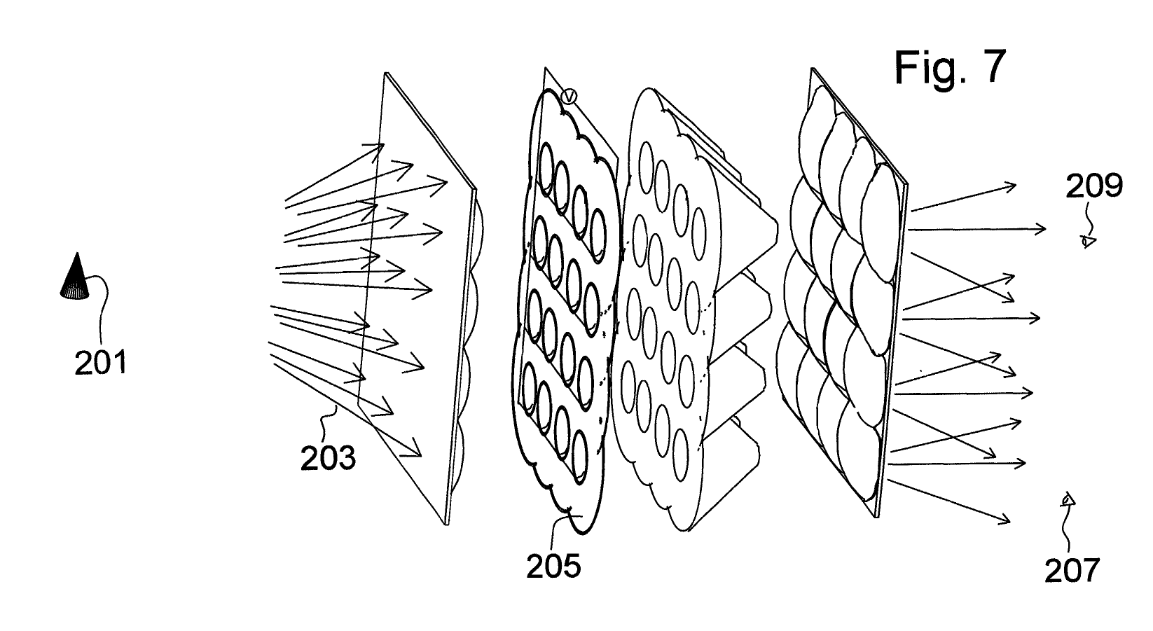

FIG. 7 is an exploded view of the first embodiment with a magnified view of an object. The components in FIG. 7 are identical to those of FIG. 6 except the regions of a PDLC magnification array 205 have been activated to produce a magnified view of an object 201. An object light ray 203 is one of many light rays from 201. Both a first object viewer 207 and a second object viewer 209 see the magnified object through the window.

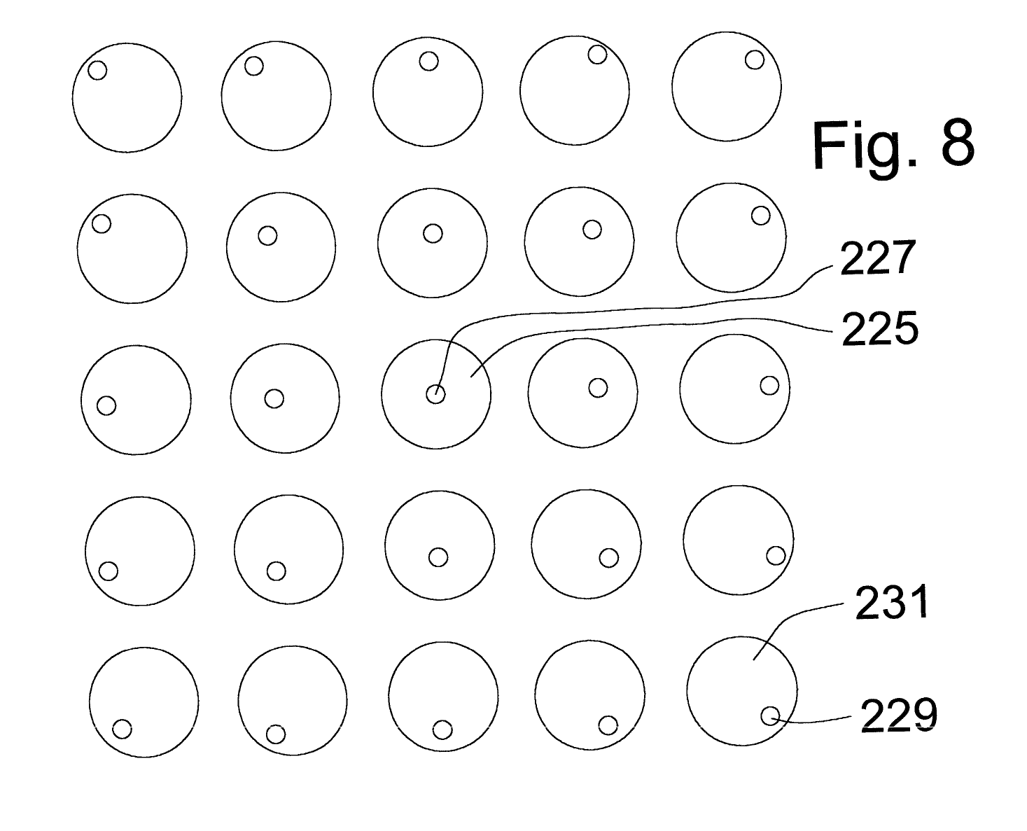

FIG. 8 illustrates the PDLC configuration that achieves the light transmittance for FIG. 7. The array of PDLC zones has been activated by electric current into a different configuration. A first zone for magnification 225 has a central activated zone at 225. A second zone for magnification has a region away from the center 229 activated. Light from the 201 passes through each of these zones and is presented to the 207 and 209 users as a magnified image.

### OPERATION OF THE INVENTION

FIG. 1 illustrates a cross section view of a single pixel cell of the present variable view window. Light from a first direction 47, light from a second direction 43, and light from a third direction 45 are all incident on the primary optic 49. 49 causes light from the three planes to form focal points along a curve. The 45 light embarks on a third altered light 51 course and focuses at one point. Note that the 51 light is prevented from passing through the 55 PDLC because it is opaque in the region of the 51 light focal point. The 47 light embarks on a first altered light 53 course and focuses. Note that the switch at 67 is closed thereby causing a current to flow from 65 through 69 and to 59 and 63. Said current causes the region of the PDLC at region 71 to be transparent. The 53 light therefore passes through the PDLC at region 71 and enters the 73 fiber optic. The light originating in trajectory 47 then emerges as light from the fiber optic 75. 75 light is incident on a final lens 77. Resultant light 79 can then be observed by the user. Note that the 47 incident light was selected from all of the possible incident light, and then redirected to suit the user. As will be illustrated later, a user viewing the 79 light will see the light from many different perspectives. The lens 77 becomes similar to a pixel on a TV where each viewer sees the same color coming from the pixel no matter where they sit relative to the TV.

FIG. 2 is a blown up portion of the PDLC liquid crystal layer of FIG. 1. The PDLC 57 can be more readily seen. Note that the PDLC 57 and the fiber optics such as 73 are positioned at the focal points of the light. Note that region 71 is transparent due to the electric current applied at 69 and 55 through 63 and 67. Since electric current has not been applied to other regions of the PDLC, light does not enter any fiber optics except a73. The PDLC and electric circuit are able to filter out and select which light trajectories will be passed through the window.

FIG. 3 is a blown up view of a gradient index lens replacing the fiber optics of FIG. 2. A gradient index lens 101 has replaced the fiber optics described in FIGS. 1 and 2. The gradient index lens is manufactured according to techniques well known. Note that light passing through the selected region of the PDLC is caused to be redirected by the 101 as redirected light 103. The light then emerges from the 101 at emerging grin light at 105. Other elements of the system are not shown but are similar to previous diagrams.

FIG. 4 illustrates an alternate embodiment where mechanical motion enables view selection. Components of the system are similar to those of FIG. 1 except that the PDLC does not reside on the curve of the focal points. The PDLC resides in a flat plane. First flat PDLC resides between a first left transparent electrode section 115 and a right transparent electrode 129. Note that the 115 is not active and the PDLC in its region is therefore opaque. A second left electrode 119 and a third left electrode 121 are activated in conjunction with 129 such that the PDLC in each of their regions is transparent. The right side of FIG. 4 is similar to the left side of FIG. 4. Note that the right side can be slid relative to the left side such that fiber optics such as a first slid fiber optic 117 on the left side can be aligned as desired with the fiber optics on the right side. This enables the user to select which light trajectories on the right will be passed through the window and what their resultant trajectories will be after emerging from the right side of the window.

FIG. 5 is an exploded view of the first embodiment with a direction of light selected. In the diagram, the user has selected a PDLC configuration (which is illustrated in FIG. 6) such that selected light 151 on a given trajectory has been selected. The light passes through the 153 and is focused by 155. Approximately at the focal point, the focused light passes through a region of the 157 (shown in FIG. 6) which has been caused to be transparent by electric current. The light then is caused to take a central trajectory by the 161 gradient lens. When it exits the gradient lens at 165, the light is caused to spread such that it covers nearly the whole surface of a single lenslet at 169. When the light exits the system at 171, it can be perceived by a first user 173 and a second user 175. Each of these users see the same color light being emitted from each specific section of the array. This is a pixilated window that enables users to see the same view from many different viewing angles similar to how viewers of a TV see the same view form many different viewing angles.

FIG. 6 illustrates the PDLC configuration that achieves the light transmittance for FIG. 5. Illustrated are the PDLC recessed regions of FIG. 5. Each PDLC recess has a small portion activated. The PDLC at 158a has an active region 177 which is transparent due to the electric current applied thereto. Since the PDLC resides along the focal curve of the lens as described in FIG. 5, a select trajectory of light passes therethrough. The PDLC array in conjunction provides a coherent view through the window with a user selected view.

FIG. 7 is an exploded view of the first embodiment with a magnified view of an object. The components in FIG. 7 are identical to those of FIG. 6 except the regions of a PDLC magnification array 205 have been activated to produce a magnified view of an object 201. An object light ray 203 is one of many light rays from 201. Both a first object viewer 207 and a second object viewer 209 see the magnified object through the window.

FIG. 8 illustrates the PDLC configuration that achieves the light transmittance for FIG. 7. The array of PDLC zones has been activated by electric current into a different configuration. A first zone for magnification 225 has a central activated zone at 225. A second zone for magnification has a region away from the center 229 activated. Light from the 201 passes through each of these zones and is presented to the 207 and 209 users as a magnified image.

### CONCLUSIONS, RAMIFICATIONS, AND SCOPE

Accordingly, several objects and advantages of my invention are apparent. It is an object of the present invention to provide a window which is nearly instantly alterable with regard to the selection of what light trajectory angles will pass therethrough. This enables the user to select what view is provided by the window. It is an object of the present invention to provide a window which is nearly instantly alterable with regard to the selection of what light trajectory angles will pass therefrom. It is an object to provide a window which enables multiple users from different viewing perspectives to view the same scene simultaneously. It is an object to enable the user to magnify the view of an object they are viewing through the window provided. It is an advantage to provide a window which achieves these objects with no physical movement required in a first embodiment and with minimal physical motion required in a second embodiment. The apparatus described is designed to be rugged, reliable, cost effective and to minimize resource requirement while being mass produced in any size or shape. It should be noted that the technology provided herein can be applied to any substantiative light transmissive optic. Accordingly it can be used for applications in any field which uses windows and/or lenses such as telecommunications, entertainment, photography, optics, science, engineering, telescopy, building architecture, automobiles, and etc. It should be noted that other configurations are possible using the art described herein. While my above description describes many specifications, these should not be construed as limitations on the scope of the invention, but rather as an exemplification of one preferred embodiment thereof Many other variations are possible.

I Claim:

1. An optical system comprising;
a lens which creates focal points in electromagnetic radiation incident thereon, wherein a means for selecting one or more focal points of electromagnetic radiation is provided, and said electromagnetic radiation from said select focal points passes through said means for selecting.

2. The optical system of claim 1, wherein electromagnetic energy passes through an electro-optic material.

3. The optical system of claim 1, wherein an array of means for selecting are operated in conjunction.

4. The optical system of claim 1 wherein the electro magnetic energy is cause to spread when exiting said optical system.

5. The optical system of claim 1 wherein the user of said system sees a magnified view of an object.

6. A method for redirecting the course of electromagnetic radiation comprising;
a means for creating a first focal point in a first electromagnetic energy ray and a second focal point in a second electromagnetic energy ray, and
a means for selecting one or more of said focal points of electromagnetic radiation is provided, and
said electromagnetic radiation from said select focal point(s) passes through said means for selecting.

7. The method of claim 6, wherein electromagnetic energy passes through an electro-optic material.

8. The method of claim 6, wherein an array of means for selecting are operated in conjunction.

9. The method of claim 6, wherein the electro magnetic energy is cause to spread when exiting said optical system.

10. The method of claim 6, wherein the user of said system sees a magnified view of an object.

11. The system of claim 1 wherein a fiber optic is used as a means to transfer electromagnetic radiation.

12. The method of claim 6 wherein a fiber optic is used to transfer electromagnetic energy.

13. The system of claim 1 wherein a gradient index lens is used to transfer electromagnetic radiation.

14. The method of claim 6 wherein a gradient index lens is used to transfer electromagnetic radiation.

15. The method of claim 6, wherein at least one optical component is located at a focal point of an optic.

16. The system of claim 1, wherein at least one optical component is located at a focal point of an optic.
